(19) United States
(12) Patent Application Publication
(10) Pub. No.: US 2006/0218505 A1
(43) Pub. Date: Sep. 28, 2006

(54) System, method and program product for displaying always visible audio content based visualization

(76) Inventors: Anthony K. Compton, New York, NY (US); Gary S. Gluck, New York, NY (US); Andrew C. O'Meara, Watertown, MA (US); Anton Shevchenko, Watertown, MA (US)

Correspondence Address: HOFFMAN WARNICK & D'ALESSANDRO, LLC, 75 STATE STREET, 14TH FLOOR, ALBANY, NY, 12207, US

(21) Appl. No.: 11/390,528

(22) Filed: Mar. 27, 2006

Related U.S. Application Data
(60) Provisional application No. 60/665,705, filed on Mar. 28, 2005.

(51) Int. Cl. G06F 3/00; G06F 17/00

(52) U.S. Cl. 715/781; 715/728

(57) ABSTRACT

As indicated above, the present invention provides system, method and program product for displaying visualization based on audio content. The invention includes an always visible area, such as a tool bar, that has at least one area for displaying visualization. When the always visible area is displayed on the computer desktop, the content that had been displayed on the computer desktop at the time the tool bar was opened is automatically resized such that both the original content and the tool bar are visible on the computer desktop. The displaying of the always visible area may also resize new content that may be opened onto the computer desktop such that both the new content and the always visible area are visible on the computer desktop. This resizing of the content displayed on the computer desktop enables the always visible area and audio content based visualization to be visible on the computer desktop at all times.

### FIELD OF THE INVENTION

The present invention generally relates to data display. Specifically, the present invention provides an always visible window for displaying graphic visualizations that are based on audio content.

### BACKGROUND OF THE INVENTION

As computers become faster and more powerful, their utility for tasks other than the traditional tasks of arithmetic computation have increased. For example, today's computers are more than simply computing devices and have evolved into devices that may provide, for example, information, communication and entertainment, as well. These types of applications help make the computer a more desirable and valuable component of everyday life.

In the area of entertainment, one of the most important characteristics of a modern computer system is its ability to play audio content. This audio content may originate from a pre-recorded medium, such as a CD; may be streamed live from a remote location, such as via the Internet; may be purchased and/or downloaded via the Internet; may be input or created by the user; or may be included in a software package. The ability of a computer to play audio content allows a user to listen to the audio content while performing other tasks on the computer due to the modern computer's ability to multi-task. This allows a computer user to make his or her environment more pleasant while performing tasks such as using a word processor, using a spreadsheet, or browsing the Internet.

The proliferation of playing of audio content by computers has also brought about a new category of applications that provide “visualization” accompanying the audio content. These visualization applications provide listeners of audio content with accompanying computer graphics that respond to the audio content being played by or through a computer. Many music visualization applications, such as the WhiteCap and G-Force applications by SoundSpectrum, Inc., display graphic images that move in response to the audio content by “sampling” the audio content. This process consequently provides a computer generated visual display that is immediately reactive to the audio content. Visualization software can run simultaneously with software applications that play music (often called “media players”), providing the user with a visual experience that is responding in real-time (or near-real time in cases where there is a slight processing delay) to the music being played by their media player.

One major challenge in the area of visualization software occurs when a user desires to have visualization software visible while the user is performing some other task. The visualization produced by visualization software is typically displayed in conjunction with a computer audio player that is playing the audio content or in a separate window. In a windowing environment, such as Microsoft Windows or the Apple Environment, the window in which the visualizations are displayed would have to be “on top” in order for the visualizations to be displayed to the user. However, in order for a user to be able to provide input to another application, such as a word processor, the other application must be on top. Furthermore, many applications either require or default to a “full screen” mode upon start up. Because of this, a user that wants to perform another task currently must either manually resize multiple windows to allow all windows to display or forgo viewing the visualization while performing other tasks.

In view of the foregoing there exists a need for a way to view audio content based visualization concurrently with other windows for performing other tasks without having to manually resize the display windows.

### SUMMARY OF THE INVENTION

In general, the present invention provides a system, method and program product for displaying visualization based on audio content. The invention includes an always visible area, such as a tool bar, that has at least one area for displaying visualization. When the always visible area is displayed on the computer desktop, the content that had been displayed on the computer desktop at the time the tool bar was opened is automatically resized such that both the original content and the tool bar are visible on the computer desktop. The displaying of the always visible area may also resize new content that may be opened onto the computer desktop such that both the new content and the always visible area are visible on the computer desktop. This resizing of the content displayed on the computer desktop enables the always visible area and audio content based visualization to be visible on the computer desktop at all times, even when another application in which the user may be working is in a maximized state.

The always visible area may be located anywhere on the computer desktop, but is preferably located adjacent to an edge of the computer desktop, such as the top, bottom, left or right edge. The always visible area may be movable by a user to whichever portion of the computer desktop the user desires and may be resizable so as to take up as much or as little of the computer desktop as the user desires. In addition, the always visible area may be include other objects, such as: a control for controlling an aspect of the non-static visual content or controls for another program, such as a multimedia player; text, icons, or graphics for displaying, among other things, information about the non-static visual content, the music being played, corporate sponsorship, advertisements, etc. In the alternative, the always visible area may be used solely to display one or more audio content based visualizations.

A first aspect of the present invention provides a system for displaying visualization based on audio content, comprising: a visualization generator for generating at least one visualization, wherein each of the at least one visualization comprises a series of visual images that are mathematically calculated based on data of the audio content; and an always visible area of a computer desktop having at least one area for displaying the at least one visualization, wherein an opening of the always visible area causes contents of the computer desktop to be automatically resized to accommodate the always visible area on the computer desktop.

A second aspect of the present invention provides a method for displaying visualization based on audio content, comprising: generating at least one visualization, wherein each of the at least one visualization comprises a series of visual images that are mathematically calculated based on data of the audio content; providing an always visible area of a computer desktop having at least one area for displaying the at least one visualization; resizing contents of the computer desktop to display both the contents and the always visible area on the computer desktop; and displaying the at least one visualization in the at least one display area.

A third aspect of the present invention provides a program product stored on a computer readable medium for displaying visualization based on audio content, the computer readable medium comprising program code for causing a computer system to perform the following steps: generate at least one visualization, wherein each of the at least one visualization comprises a series of visual images that are mathematically calculated based on data of the audio content; provide an always visible area of a computer desktop having at least one area for displaying the at least one visualization, resize contents of the computer desktop to display both the contents and the always visible area on the computer desktop; and display the at least one visualization in the at least one display area.

A fourth aspect of the present invention provides a method for deploying an application for displaying visualization based on audio content, comprising: providing a computer infrastructure being operable to: provide an always visible area of a computer desktop having at least one area for displaying the at least one visualization, resize contents of the computer desktop to display both the contents and the always visible area on the computer desktop; and display the at least one visualization in the at least one display area.

A fifth aspect of the present invention provides computer software embodied in a propagated signal for displaying visualization based on audio content, the computer software comprising instructions for causing a computer system to perform the following steps: generate at least one visualization, wherein each of the at least one visualization comprises a series of visual images that are mathematically calculated based on data of the audio content; provide an always visible area of a computer desktop having at least one area for displaying the at least one visualization, resize contents of the computer desktop to display both the contents and the always visible area on the computer desktop; and display the at least one visualization in the at least one display area.

Therefore, the present invention provides a method, tool, and program product for displaying visualization based on audio content.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative computer system having a system for displaying visualization based on audio content according to the present invention.

FIG. 2 shows a computer screen shot according to one embodiment of the present invention.

FIG. 3 shows a computer screen shot according an alternate embodiment of the present invention.

FIG. 4 shows a computer screen shot according an alternate embodiment of the present invention.

FIG. 5 shows a computer screen shot according an alternate embodiment of the present invention.

FIG. 6 shows a computer screen shot according an alternate embodiment of the present invention.

FIG. 7 shows a computer screen shot according an alternate embodiment of the present invention.

FIG. 8 shows a computer screen shot according an alternate embodiment of the present invention.

FIG. 9 shows a computer screen shot according an alternate embodiment of the present invention.

FIG. 10 shows an illustrative method flow diagram according to the present invention.

It is noted that the drawings of the invention are not to scale. The drawings are intended to depict only typical aspects of the invention, and therefore should not be considered as limiting the scope of the invention. In the drawings, like numbering represents like elements between the drawings.

### BEST MODE FOR CARRYING OUT THE INVENTION

As indicated above, the present invention provides system, method and program product for displaying visualization based on audio content. The invention includes an always visible area, such as a tool bar, that has at least one area for displaying visualization. When the always visible area is displayed on the computer desktop, the content that had been displayed on the computer desktop at the time the tool bar was opened is automatically resized such that both the original content and the tool bar are visible on the computer desktop. The displaying of the always visible area may also resize new content that may be opened onto the computer desktop such that both the new content and the always visible area are visible on the computer desktop. This resizing of the content displayed on the computer desktop enables the always visible area and audio content based visualization to be visible on the computer desktop at all times, even when another application in which the user may be working is in a maximized state.

The always visible area may be located anywhere on the computer desktop, but is preferably located adjacent to an edge of the computer desktop, such as the top, bottom, left or right edge. The always visible area may be movable by a user to whichever portion of the computer desktop the user desires and may be resizable so as to take up as much or as little of the computer desktop as the user desires. In addition, the always visible area may include other objects, such as: a control for controlling an aspect of the non-static visual content or controls for another program, such as a multimedia player; text, icons, or graphics for displaying, among other things, information about the non-static visual content, the music being played, corporate sponsorship, advertisements, etc. In the alternative, the always visible area may be used solely to display one or more audio content based visualization.

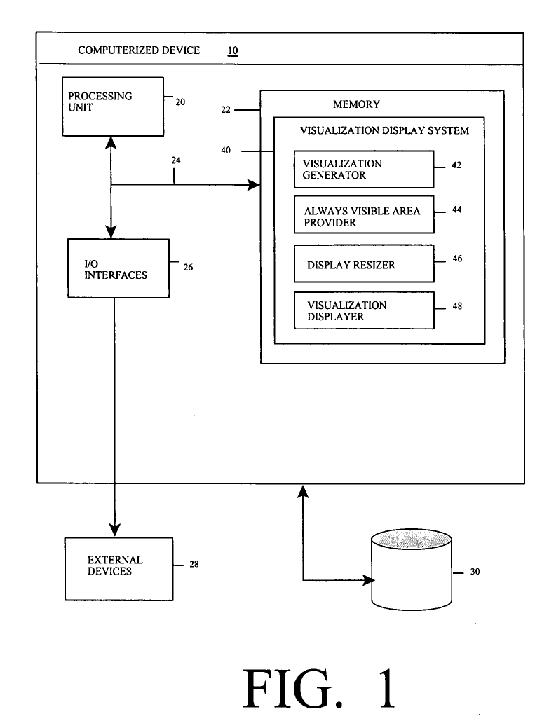

FIG. 1 shows an example of a computerized device 10 on which the present invention can be implemented. As depicted, computerized device 10 includes a processing unit 20, a memory 22, a bus 24, and an input/output (I/O) interfaces 26. Further, computerized device 10 is shown in communication with external I/O devices/resources 28 and storage system 30. In general, processing unit 20 executes computer program code, such as visualization display system 40, which is stored in memory 22 and/or storage system 30. While executing computer program code, processing unit 20 can read and/or write data, to/from memory 22, storage system 30, and/or I/O interfaces 26. Bus 24 provides a communication link between each of the components in computerized device 10. External devices 28 can comprise any devices (e.g., keyboard, pointing device, display, etc.) that enables a user to interact with computerized device 10 and/or any devices (e.g., network card, modem, etc.) that enables computerized device 10 to communicate with one or more other computing devices.

Computerized device 10 is only representative of various possible computer infrastructures that can include numerous combinations of hardware. To this extent, in other embodiments, computerized device 10 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 20 may comprise a single processing unit, or be distributed across one or more processing units in one or more locations, e.g., on a client and server. Similarly, memory 22 and/or storage system 30 can comprise any combination of various types of data storage and/or transmission media that reside at one or more physical locations. Further, I/O interfaces 26 can comprise any system for exchanging information with one or more external devices 28. Still further, it is understood that one or more additional components (e.g., system software, math co-processing unit, etc.) not shown in FIG. 1 can be included in monitoring system 14. However, if computerized device 10 comprises a handheld device or the like, it is understood that one or more external devices 28 (e.g., a display) and/or storage system(s) 30 could be contained within monitoring system 14, not externally as shown.

Storage system 30 can be any type of system (e.g., a database) capable of providing storage for information under the present invention. To this extent, storage system 30 could include one or more storage devices, such as a magnetic disk drive or an optical disk drive. In another embodiment, storage system 30 includes data distributed across, for example, a local area network (LAN), wide area network (WAN) or a storage area network (SAN) (not shown). Although not shown, additional components, such as cache memory, communication systems, system software, etc., may be incorporated into computerized device 10.

Shown in memory 22 of computerized device 10 is visualization display system 40 of the present invention, which includes a visualization generator 42, an always visible area provider 44, a display resizer 46 and a visualization displayer 48. While the above listed components of visualization display system 40 are listed as being separate components, it is to be understood that different ones of the components may be combined, or, in the alternative divided into still further components. Furthermore, while each of the listed components is shown as being a part of visualization display system 40, it should be understood by those who are skilled in the art that various ones of the components may be provided by other systems. For example, always visible area provider 44 and/or display resizer 46 may, in some environments, be provided by the operating system of computerized device 10.

In any case, visualization generator 42 generates at least one visualization to be displayed by visualization display system 40. Each visualization generated by visualization generator 42 comprises a series of visual images that are mathematically calculated based on data of audio content being played on computerized device 10. Audio content may be received for playing by computerized device 10 in a variety of ways, such as by retrieving the audio content from storage system 30 of computerized device 10; by input from external devices 28; from a network, such as the Internet; by retrieving the audio content via a media player or from an operating system component; or by any way of getting audio content to be played by computerized device 10 that is now known or later developed.

In any case, the visualization that is generated by visualization generator 42 is comprised of a series of visual images that are based on the audio content. To this extent, visualization generator 42 may include algorithms, mathematical functions, and/or randomization functions, for generating each visual image. In addition, visualization generator 42 may include one or more smoothers for ensuring that the visual images morph smoothly from one to another in the visualization. In the exemplary generation of a visual image that makes up the visualization, a user or randomization function may determine an algorithm that indicates a type of visualization to be displayed, such as, but not limited to, geometric shapes, curves, rotating patterns, bursts, clouds, etc. A randomize function and/or the user may also be used to choose a color pallet for the visualization. A randomize function may then select one or a plurality of mathematical functions for use in generating the visual images that comprise the visualization. Data from the audio content, such as digitized values of the audio content that pertain to, for example, timing, volume, instrumentation, bass/treble mixture, etc., are plugged into the mathematical functions; a randomized value or seed is possibly added; the results are combined with the color pallet; a scaling factor may be incorporated; and the results are used by the algorithm to generate the series of visual images. As can be seen from the variety of algorithms, mathematical functions, color pallets and randomized values, the varieties of generated visualization are virtually endless. However, because the visual images that make up the visualization are based on the audio content itself, the visualization changes in response to changes in the audio content.

Always visible area provider 44 provides an always visible area of a computer desktop while causing contents of the computer desktop to be automatically resized to accommodate the always visible area on the computer desktop, such as by use of display resizer 46. In doing so, always visible area provider 44 may provide an always visible area in a variety of ways. For example, in a Microsoft Windows environment, an “application desktop toolbar” (aka the “appbar” application programming interface (API)) may be employed. The appbar is anchored to an edge of the display, and it traditionally contains controls/buttons that give the user quick access to other applications and windows. MS Windows prevents other applications from using the computer desktop area occupied by an appbar. MS Windows maintains information about each appbar and sends the appbars messages to notify them about events that can affect their size, position, and appearance (e.g., resize events).

In contrast, in an alternate environment, such as an Apple environment, always visible area provider 44 may display the always visible area. In addition, display resizer 46 may simultaneously issue commands to other windows on the display to prevent the other windows from infringing upon or overlapping always visible area. In the alternative, other windows on the display may remain their original size and the always visible area may be rendered translucent to allow a user to see the always visible area as well as the content whose area it shares. Translucency of the always visible area may be adjustable by the user and/or the always visible area may be temporarily toggled visible or not visible via a user controls or an external device such as a mouse pointer to allow for an unobstructed view of the content whose area it shares. Still further, in these, or other environments, an overwrite buffer of the display may be manipulated to become visible, a video card interface may be provided, the operating system may be “fooled” and/or output from the operating system to the video device may be captured and changed in order to create always visible area. In short, any manner of creating an always visible area listed above, now known or later developed may be used by always visible area provider 44 to provide always visible area. The varieties of manners in which always visible area provider 44 may provide always visible area make it applicable to any platform and/or operating system.

Always visible area provided by always visible area provider 44 has at least one area for displaying the at least one visualization. In one embodiment, the at least one area for displaying the at least one visualization may comprise the entirety of the always visible area. In contrast, in an alternative environment, the at least one area for displaying the at least one visualization may comprise only a portion of the always visible area, with the remainder comprising such content as a media player, controls, information about the media content being played, a browser, advertisements, etc. In any case, only one area of the always visible area may be allocated for displaying one or a plurality of visualizations or, in the alternative, the always visible area may have a plurality of contiguous or non-contiguous areas for displaying a single or a plurality of visualizations. The area or areas may be fixed within the always visible area, or may, alternatively, expand, contract, and/or change position within the always visible area.

One or more controls may also be included within the always visible area. Controls may be in the form of one or more control buttons, drop down menus, sizing controls and/or location controls, among others. Controls may be visible in the always visible area or, in the alternative, may be event driven, such as by a mouse placement, click, or drag operation. In any case, controls may be used to, for example, close the always visible area, resize the always visible area, and/or change the location of the always visible area. In addition, the controls may be used to, for instance, change the location of one or more areas for displaying the visualizations within the always visible area; to change the size, number, fixedness, and/or location of a particular visualization within the area for displaying the visualizations; or to change attributes of a visualization itself, such as color, gain, pattern, etc.

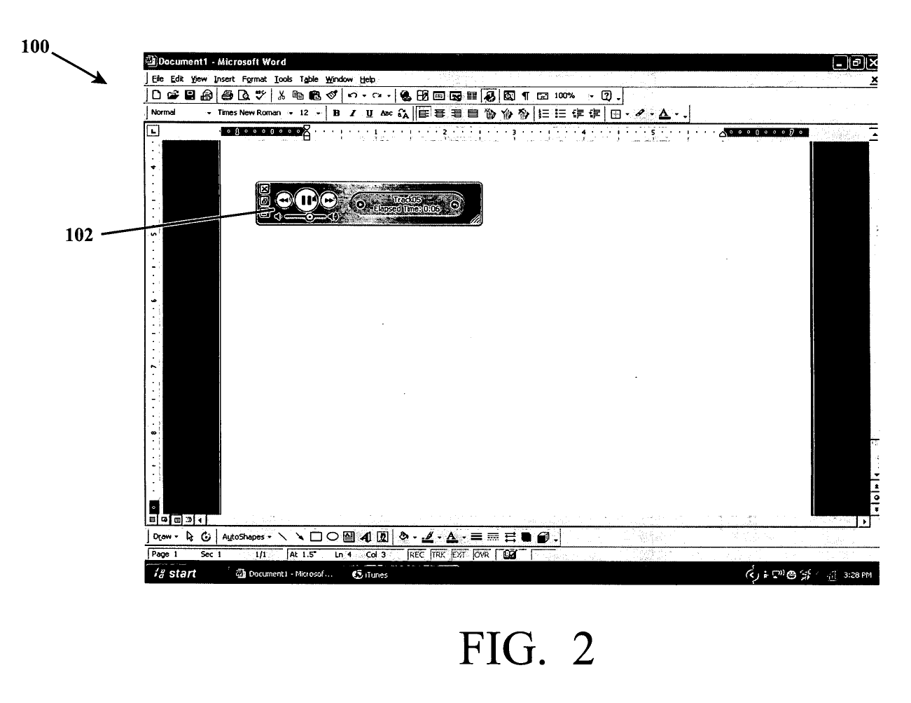

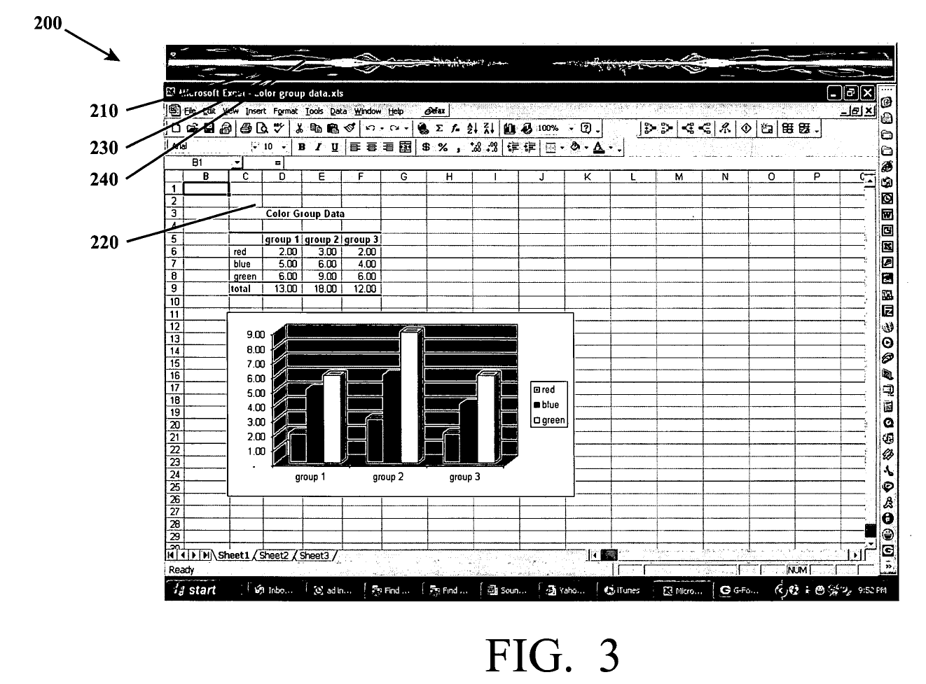

Referring to FIGS. 1-4 concurrently, display of an always visual area 210 by always visible area provider 44 and resizing of the computer desktop by display resizer 46 are shown. FIG. 2 shows a display 100, which, in this example, is displayed using the Microsoft Windows operating system. Display 100 includes an audio player 102 for playing audio content. FIG. 3 illustrates a modified display 200 after always visual area 210 has been displayed by always visible area provider 44. Always visible area 210 could be provided automatically with the opening of music player 102 (FIG. 1) and/or the beginning of the playing of the audio content. In the alternative, always visual area 210 may be instantiated by a command by the user, such as the activation of a control, for instance a command button, on the audio player itself, the activation of a control on a secondary window of the audio player, and/or the running of a separate program that is not part of the audio player itself. In any case, always visible area 210 is displayed so as to be always visible to the user while the previous contents 220 of display are automatically resized to accommodate always visible area 210 on display. Always visible area 210 includes at least one display area 230 for displaying at least one visualization 240.

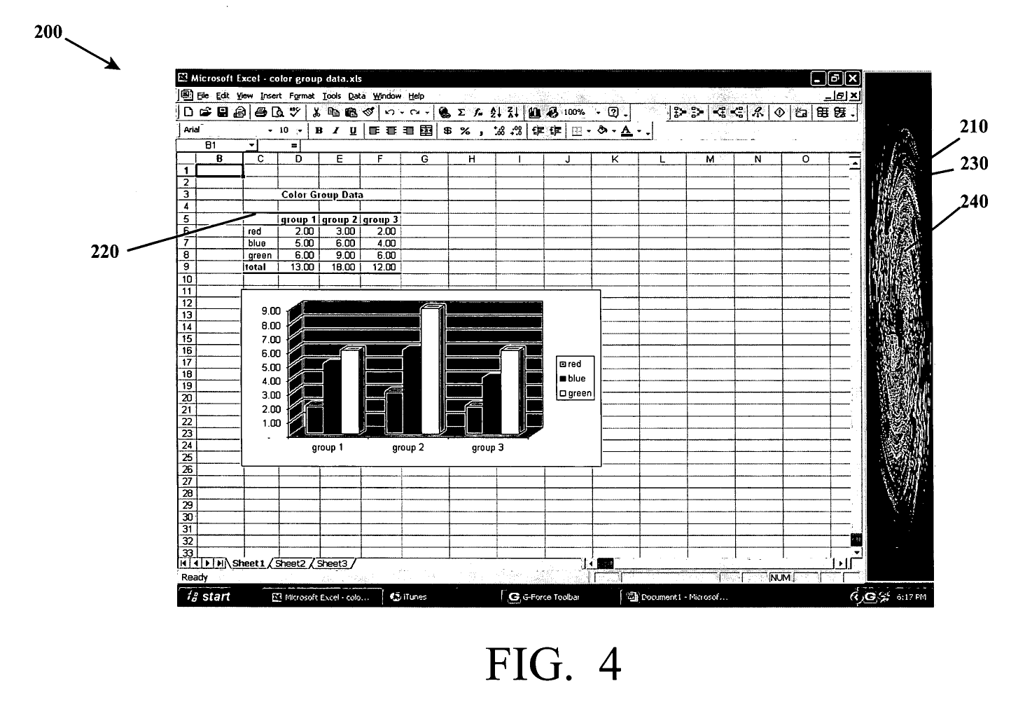

In contrast to FIG. 3 in which always visible area 210 is provided at the top of display 200, FIG. 4 shows always visible area 210 provided at the right edge of display 200 and previous contents 220 of display 200 automatically resized accordingly. Always visible area 210 may be provided anywhere on the display, such as in a corner of display 200 and/or a box or stripe in the middle of display 200, although always visible areas 210 along the top, bottom, right, and left edges of display 200 are preferred. Furthermore, multiple always visible areas 210 may be provided, including, but not limited to top and bottom; left and right; and/or top, bottom, left and right edges of display 200.

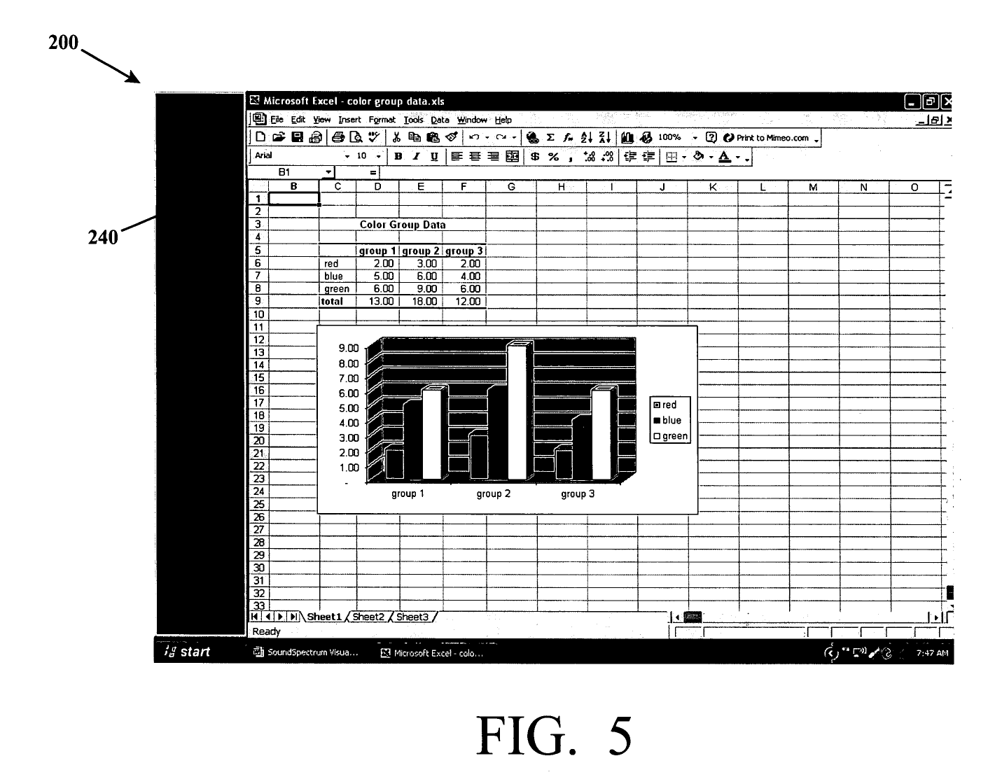

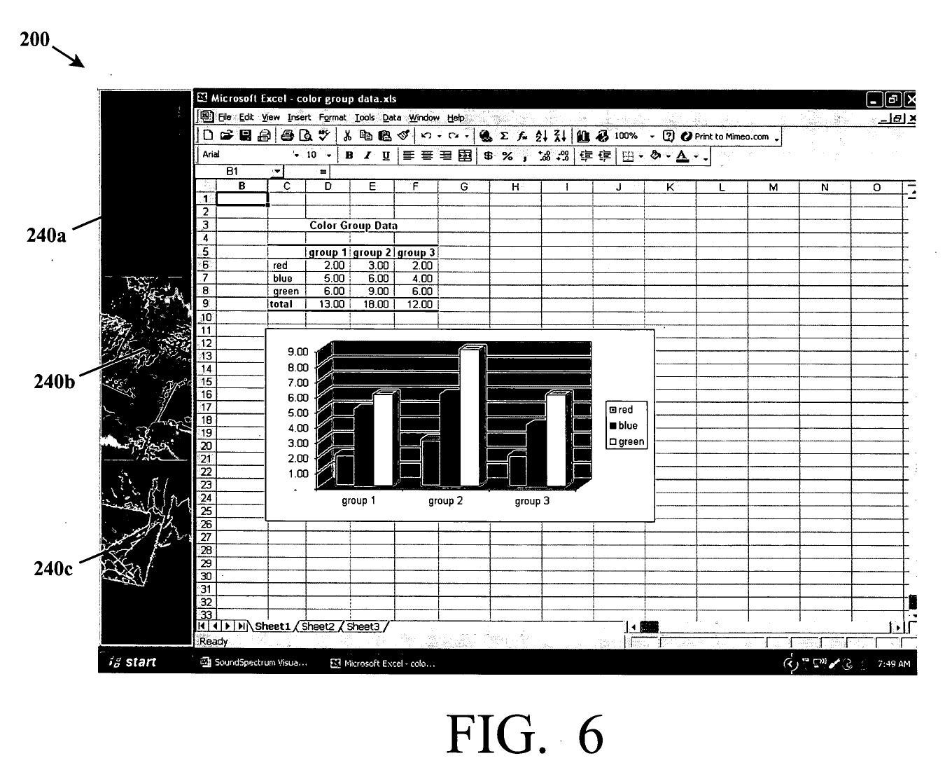

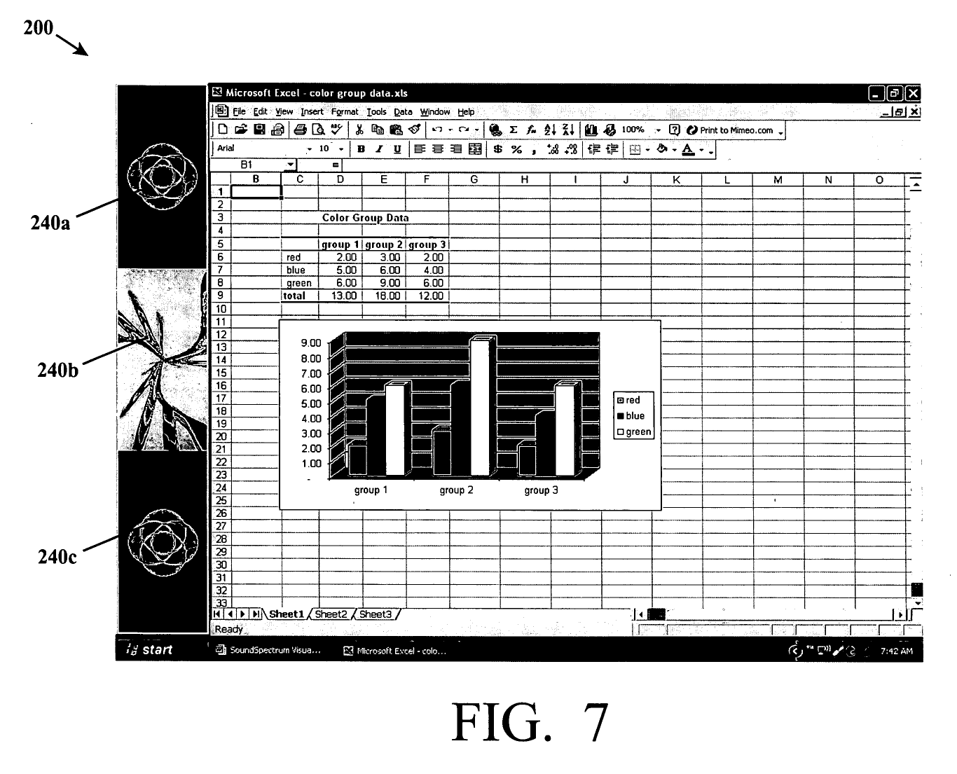

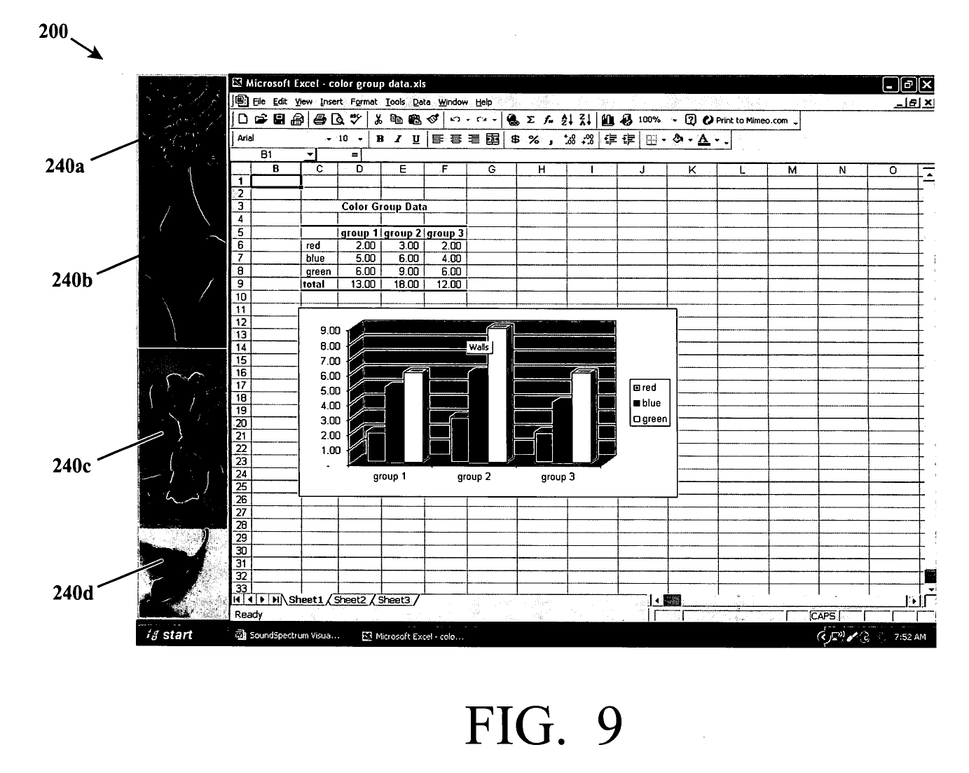

Referring now to FIG. 1 in conjunction with FIGS. 5-9, visualization displayer 48 displays the at least one visualization 240 in the at least one display area 230 (FIGS. 3-4). Visualization 240 may be displayed by visualization displayer 48 in any number of different ways. While examples of several different ways are shown herein, these are provided by way of example only and are in no way meant to be limiting. FIG. 5 shows a display 200 with a single visualization 240. FIG. 6, in contrast, shows a display 200 with three different visualizations 240a-c being displayed simultaneously by visualization displayer 48. Please take note that any or all of visualizations 240a-c of this figure (as well as any of the following FIGS. 7 and 9, in which multiple different visualizations are illustrated) may be generated using the same visualization generator 42, or in the alternative, different visualization generators 42 may be used to generate any or all of the visualizations 240a-c. Furthermore, any or all of the visualizations may be displayed in the same or different display areas 230 (FIGS. 3-4). Still further, controls could be used to control one visualization 240a-c independently or, in the alternative, more than one simultaneously.

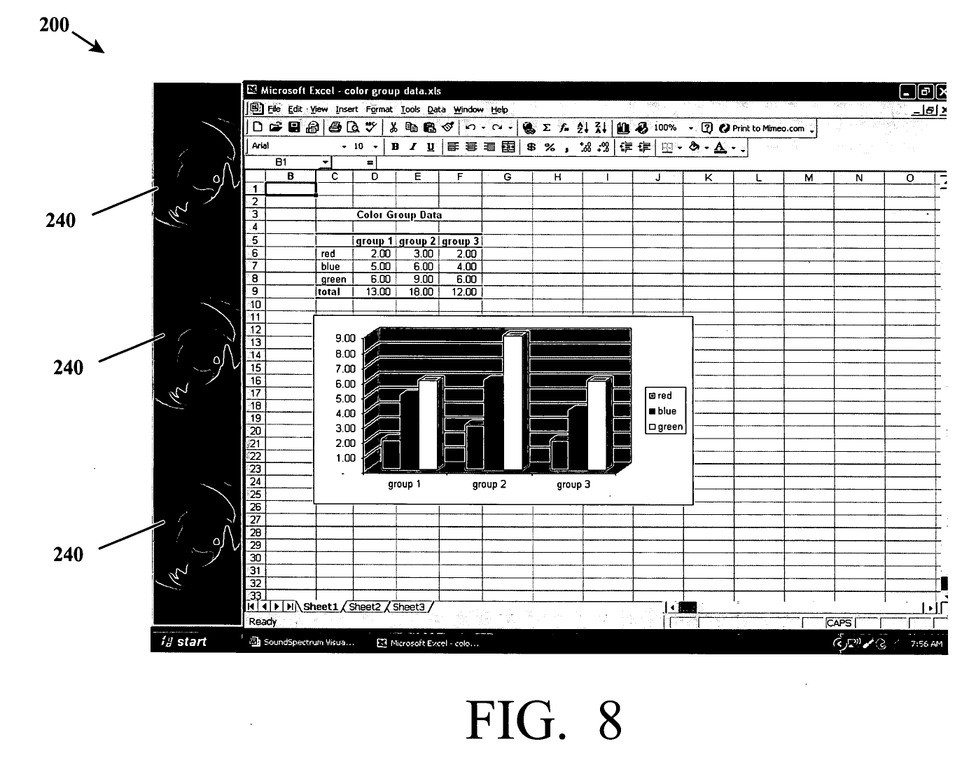

FIG. 7 shows a display 200 in which visualizations 240a and 240c and identical, while visualization 240b is different. Visualizations 240a-c in display 200 are both symmetrical and comprise a repeating pattern, although both conditions do not have to be true simultaneously. In contrast, FIG. 8 shows display 200 having three visualizations 240, all of which are the same. Finally, FIG. 9 shows display 200 having multiple visualizations 240a-d that are scrolling from one end of the always visible area to the other. This scrolling can be accomplished by moving several display areas within the always visible and/or moving several visualizations within a single display area. FIG. 9 shows visualizations 240a-d as all distinct. However, any of the above illustrated patterns or any other pattern now known or later developed could be scrolled in this manner.

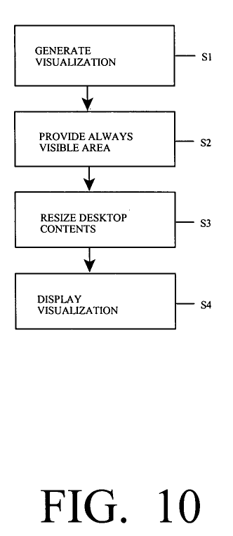

Turning now to FIG. 10, a flow chart of a method according to an embodiment of the present invention is depicted. FIG. 10 will be described with reference to FIG. 1. In first step S1 visualization generator 42 generates at least one visualization. As stated above, each visualization generated by visualization generator 42 comprises a series of visual images that are mathematically calculated based on data of the audio content. In step S2 always visible area provider 44 provides an always visible area of a computer desktop and/or display. The always visible area provided by always visible area provider 44 has one or more areas for displaying one or more visualizations. In step S3, display resizer 46 resizes the contents of the computer desktop to display both the previously displayed contents in their entirety and the always visible area on the computer desktop. Finally, in step S4, visualization displayer 48 displays one or more visualizations in the one or more display areas of the always visible area.

It should be understood that the present invention is typically implemented as a software product that is loaded on a computerized system such as a laptop computer, a desktop computer, a workstation, a handheld device, a client, a server, etc. In addition, the present invention can be can be deployed and/or implemented by a service provider providing non-static visual content such as music visualization.

Moreover, the present invention could be provided and/or implemented over a network (e.g., the Internet, a wide area network (WAN), a local area network (LAN), a virtual private network (VPN), etc. Communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet.

While shown and described herein as a method, system and program product for displaying non-static visual content, it is understood that the invention further provides various alternative embodiments. For example, in one embodiment, the invention provides a computer-readable medium that includes computer program code to enable a computer infrastructure to display non-static visual content. To this extent, the computer-readable medium includes program code that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 22 (FIG. 1) and/or storage system 30 (FIG. 1) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider, such as an Internet Service Provider, could offer to display non-static visual content as described above. In this case, the service provider can create, maintain, support, etc., a computer infrastructure that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a method for displaying non-static visual content. In this case, a computer infrastructure, such as computerized device 10 (FIG. 1) and/or a computer infrastructure in which it is implemented, can be provided and one or more systems for performing the process steps of the invention can be obtained (e.g., created, purchased, used, modified, etc.) and deployed to the computer infrastructure. To this extent, the deployment of a system can comprise one or more of (1) installing program code on a computing device, such as computerized device 10 (FIG. 1), from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A system for displaying visualization based on audio content, comprising:
a visualization generator for generating at least one visualization, wherein each of the at least one visualization comprises a series of visual images that are mathematically calculated based on data of the audio content; and
an always visible area provider for providing an always visible area of a computer desktop having at least one area for displaying the at least one visualization,
wherein an opening of the always visible area causes contents of the computer desktop to be automatically resized to accommodate the always visible area on the computer desktop.

2. The system of claim 1, wherein the area for displaying the at least one visualization comprises an entirety of the always visible area.

3. The system of claim 1, wherein the area for displaying the at least one visualization displays multiple visualizations generated by multiple visualization generators.

4. The system of claim 1, wherein the always visible area is located adjacent to an edge of the computer desktop.

5. The system of claim 4, wherein the always visible area may be moved from being adjacent to one edge to another edge of the computer desktop.

6. The system of claim 1, wherein the always visible area is an application desktop toolbar in a Microsoft Windows environment.

7. The system of claim 1, wherein the tool bar further includes at least one control.

8. The system of claim 7, wherein the control controls an aspect of the visualization.

9. A method for displaying visualization based on audio content, comprising:
generating at least one visualization, wherein each of the at least one visualization comprises a series of visual images that are mathematically calculated based on data of the audio content;
providing an always visible area of a computer desktop having at least one area for displaying the at least one visualization;
resizing contents of the computer desktop to display both the contents and the always visible area on the computer desktop; and
displaying the at least one visualization in the at least one display area.

10. The method of claim 9, wherein the at least one area for displaying the at least one visualization comprises an entirety of the always visible area.

11. The method of claim 9, wherein the at least one area for displaying the at least one visualization comprises multiple areas, each area for displaying a visualization generated by one of multiple visualization generators.

12. The method of claim 9, wherein the always visible area is located adjacent to an edge of the computer desktop.

13. The method of claim 12, wherein the always visible area may be moved from being adjacent to one edge to another edge of the computer desktop.

14. The method of claim 9, wherein the always visible area is an application desktop toolbar in a Microsoft Windows environment.

15. The method of claim 9, wherein the always visible area further includes at least one control.

16. The method of claim 15, wherein the control controls an aspect of the visualization.

17. A program product stored on a computer readable medium for displaying visualization based on audio content, the computer readable medium comprising program code for causing a computer system to perform the following steps:
generate at least one visualization, wherein each of the at least one visualization comprises a series of visual images that are mathematically calculated based on data of the audio content;
provide an always visible area of a computer desktop having at least one area for displaying the at least one visualization,
resize contents of the computer desktop to display both the contents and the always visible area on the computer desktop; and
display the at least one visualization in the at least one display area.

18. The program product of claim 17, wherein the at least one area for displaying the at least one visualization comprises an entirety of the always visible area.

19. The program product of claim 17, wherein the at least one area for displaying the at least one visualization comprises multiple areas, each area for displaying a visualization generated by one of multiple visualization generators.

20. The program product of claim 17, wherein the always visible area is at least one of an application desktop toolbar in a Microsoft Windows environment.
